(19) United States
(12) Patent Application Publication
(10) Pub. No.: US 2013/0102176 A1
(43) Pub. Date: Apr. 25, 2013

(54) Sealed cable assembly and method of assembly

(71) Applicant: Dean L. Kazubowski, Bradford, IL (US)

(72) Inventor: Dean L. Kazubowski, Bradford, IL (US)

(73) Assignee: CATERPILLAR INC., Peoria, IL (US)

(21) Appl. No.: 13/279,069

(22) Filed: Oct. 21, 2011

(51) Int. Cl. H01R 13/52; H01B 13/20

(52) U.S. Cl. 439/275; 29/828

(57) ABSTRACT

An electrical cable assembly has a housing with a sealing cavity. A plurality of electrically conductive terminals are terminated to a wire of a cable at a termination junction. Each terminal is positioned within the housing with the termination junctions positioned within the sealing cavity. A dielectric sealing insert having a first dielectric layer and a second dielectric layer is located within the sealing cavity to surround each termination junction. A method of assembling the electrical cable assembly is also provided.

### TECHNICAL FIELD

This disclosure relates generally to an electrical cable assembly and, more particularly, to an electrical cable assembly having a sealed electrical connector at one or both ends thereof.

### BACKGROUND

Electrical cable assemblies are often used when connecting two or more electrical components. In severe or harsh environmental conditions, the electrical cable assemblies may be provided with sealing elements to prevent ground faults and other undesirable electrical failures. Various materials may be used as sealing elements including preformed insulators as well as insulators that are formed within the electrical cable assembly during the assembly process. Such cable assemblies are configured to maintain a desired level of electrical isolation between electrical components within the rated operating conditions.

U.S. Pat. No. 5,626,486 discloses a high voltage, low current electrical cable assembly. Such electrical cable assembly includes mating terminal pairs that are insulated at their mating interface and within the electrical connector housings. Such insulators may include both rigid dielectric materials and elastomeric materials.

### SUMMARY

In one aspect, an electrical cable assembly for mating with a mating connector is provided. The electrical cable assembly has a housing with a mating end, a cable end, and a sealing cavity between the mating end and the cable end. A cable has a plurality of electrically conductive wires therein with each electrically conductive wire having a dielectric sheath therearound. A plurality of electrically conductive terminals are positioned within the housing with each electrically conductive terminal being terminated to one of the electrically conductive wires at a termination junction. Each termination junction is positioned within the sealing cavity. A dielectric terminal support is provided for supporting a portion of the electrically conductive terminals in a spaced apart array. A dielectric sealing insert is located within the sealing cavity to surround each termination junction. The dielectric sealing insert has a first dielectric layer and a second dielectric layer.

In another aspect, a method is provided for assembling an electrical cable assembly. A cable having a plurality of electrically conductive wires is provided. Each electrically conductive wire has a dielectric sheath therearound. An electrical connector assembly having a housing and plurality of electrically conductive terminals is provided. The housing includes a mating end, a cable end, and a sealing cavity between the mating end and the cable end. An electrically conductive terminal is terminated to each electrically conductive wire at a termination junction. Each termination junction is within the sealing cavity. A first dielectric layer and a second dielectric layer is inserted in to a sealing cavity to form a dielectric insert within the sealing cavity. Each termination junction is sealed within the dielectric sealing insert.

### BRIEF DESCRIPTION OF THE DRAWINGS

FIG. 1 is a perspective view of one end of an electrical cable assembly;

FIG. 2 is a top plan view, partially in section, of the electrical cable assembly of FIG. 1;

FIG. 3 is an exploded view of the electrical cable assembly of FIG. 1 taken from a different perspective; and

FIG. 4 is a sectional view taken generally along line 4-4 of FIG. 2.

### DETAILED DESCRIPTION

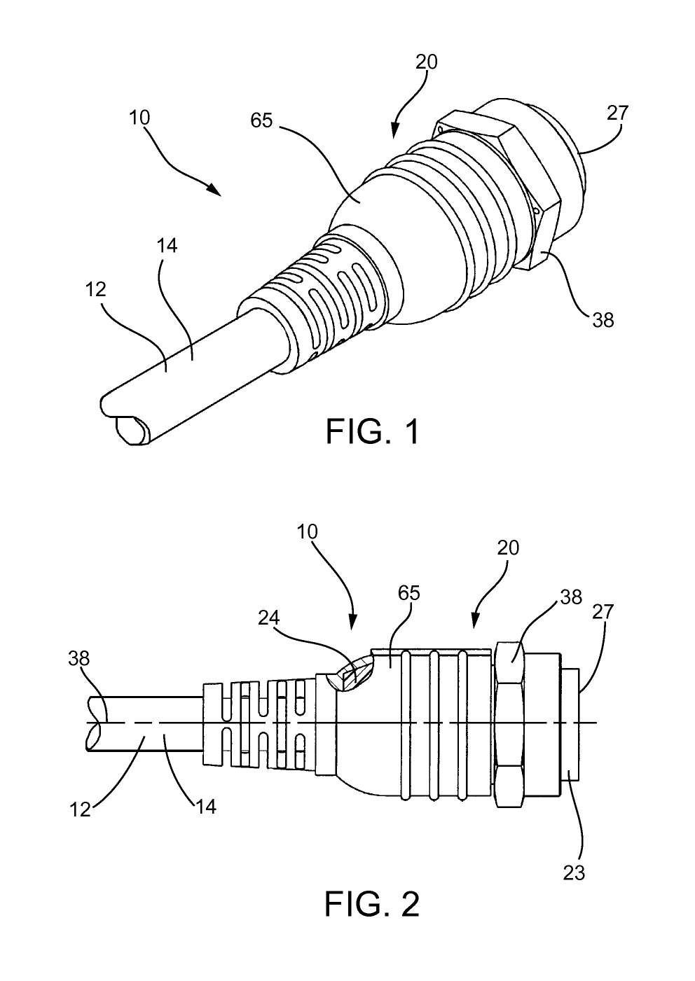

Referring to FIGS. 1-3, one end of an electrical cable assembly 10 is depicted. Electrical cable assembly 10 may include an electrical connector 20 terminated to one or both ends of an electrical cable 12. Electrical cable 12 includes a plurality of electrically conductive wires 13 extending the length thereof and surrounded by a cable dielectric sheath 14. Each electrically conductive wire 13 has a conductor 15 and an outer dielectric sheath 16 that surrounds and insulates the conductors 15. The conductors 15 may take various forms such including a plurality of stranded wires or a single solid wire and are made from a conductive material such as copper.

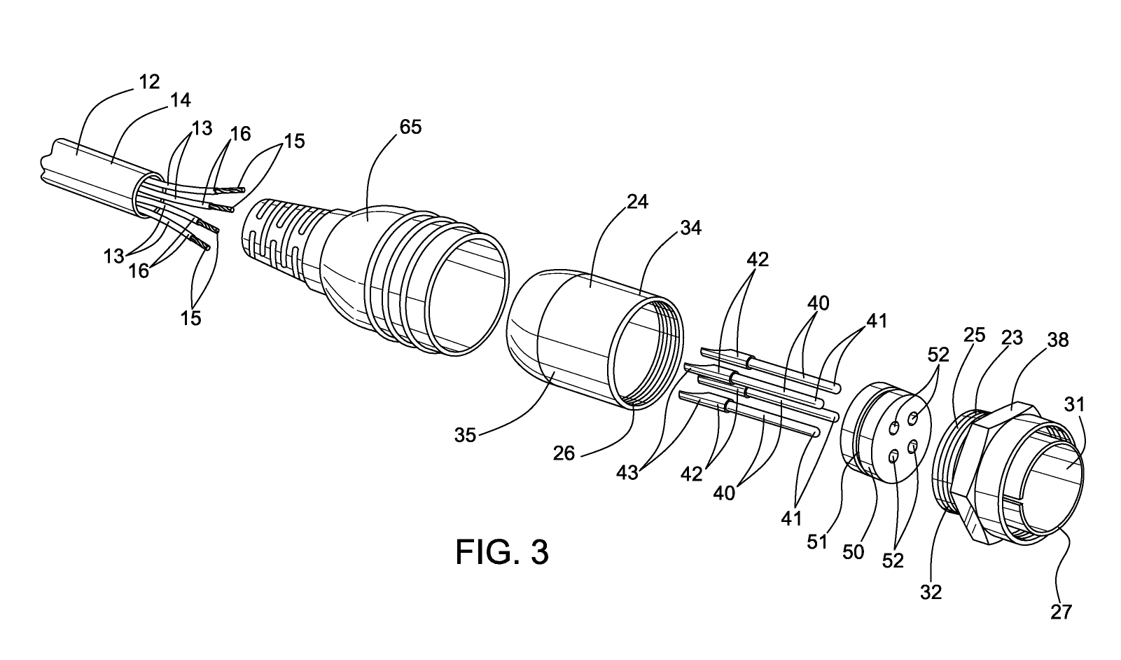

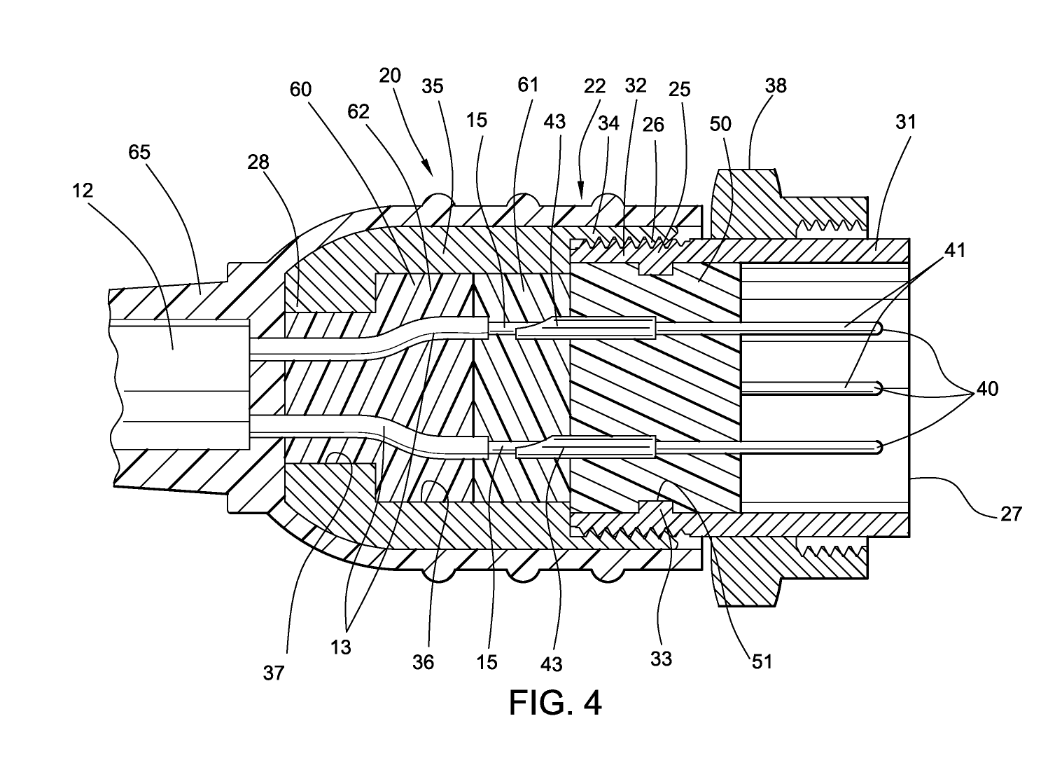

As best seen in FIGS. 3-4, electrical connector 20 has a housing 22 with a plurality of electrically conductive terminals 40 positioned within a dielectric terminal support 50. Each electrically conductive terminal 40 has a contact end 41 for mating with and establishing an electrical connection to a mating component (not shown) such as a mating electrical connector along mating axis 17. Each electrically conductive terminal 40 may also include a body section 42 for securing the electrically conductive terminal within the dielectric terminal support 50 and a termination end 43. As depicted, termination end 43 is configured as a solder cup to facilitate soldering the conductor 15 of one of the electrically conductive wires 13 to the electrically conductive terminal 40 to create a termination junction between the electrically conductive wire and the electrically conductive terminal. In some circumstances, the electrically conductive wires 13 may be terminated to the electrically conductive terminals 40 in other manners such as, for example, by crimping. Although the electrically conductive terminals 40 are depicted with a male or post-shaped contact end 41, the contact end may be configured with a female or receptacle contact end.

Housing 22 may be generally cylindrical and include a first housing component 23 and a second housing component 24. The first housing component 23 may include a threaded section 25 along an outer surface thereof that interacts with a threaded section 26 along an inner surface of the second housing component 24. The threaded section 25 of the first housing component and the threaded section 26 of the second housing component interact to secure the first housing component 23 and the second housing component 24 together. When secured together, first housing component 23 and second housing component 24 interact to form the generally cylindrical housing 22. Housing 22 has a mating end 27 generally adjacent contact ends 41 of the electrically conductive terminals 40 and a cable end 28 opposite the mating end and from which the electrical cable 12 extends from the housing 22.

First housing component 23 may be generally cylindrical and has a mating section 31 and a terminal support section 32. The mating section 31 is generally hollow and has the contact ends 41 of the electrically conductive terminals 40 extending therethrough. The terminal support section 32 has the dielectric terminal support 50 positioned therein and may include an annular ridge 33 that interacts with an annular recess 51 of the dielectric terminal support 50 to secure the dielectric terminal support 50 within the first housing component 23. Threaded section 25 may extend along an outer surface of the terminal support section 32. A threaded locking nut 38 may be mounted on the first housing component 23. Although the mating section 31 is configured as a receptacle to receive a plug section of a mating connector (not shown), the mating section 31 of the first housing component may be configured as a plug section.

The second housing component 24 may be generally cylindrical and has a hollow forward section 34 with a threaded section 26 along an inner surface thereof for securing to the threaded section 25 of the first housing component 23. The sealing section 35 of the second housing component 24 is positioned rearward of the hollow forward section 34 and has a generally cylindrical sealing cavity 36 for receiving a dielectric sealing insert 60 therein. An opening 37 may be formed at the cable end 28 of the second housing component 24 and provide access to the sealing cavity 36. In addition, the electrically conductive wires 13 may exit from the electrical connector 20 through the opening 37. First housing component 23 and second housing component 24 may be made of a durable material such as metal. In one configuration, first housing component 23 may be made of die cast aluminum and second housing component 24 may be made of die cast zinc.

Dielectric terminal support 50 is generally cylindrical and has a plurality of bores 52 extending therethrough generally parallel to the mating axis 17 of the electrical connector 20 for receiving the electrically conductive terminals 40 therein. An annular recess 51 may extend along an outer surface thereof and interact with annular ridge 33 of the first housing component 23 to secure the dielectric terminal support 50 within the first housing component. Dielectric terminal support 50 may be made of a non-conductive rubber or elastomeric material such as neoprene. Other materials having similar properties or achieving similar results may also be used.

The sealing cavity 36 of second housing component 24 may be filled with a dielectric sealing insert 60. Dielectric sealing insert 60 has a first dielectric layer 61 and a second dielectric layer 62. The first dielectric layer 61 and the second dielectric layer 62 may be formed of identical or different materials and combine to form the dielectric sealing insert 60. In one embodiment, the first dielectric layer 61 and the second dielectric layer 62 may be formed of an epoxy. The dielectric sealing insert 60 is sufficient to surround or seal and insulate the termination junction at which the conductor 15 of each electrically conductive wire 13 is terminated to the termination section 43 of each electrically conductive terminal 40. In addition, the first dielectric layer 61 engages the rearward surface 53 (towards the cable end 28 of the second housing component 24) of the dielectric terminal support 50 and the entire dielectric sealing insert 60 may extend to and engage the outer surfaces of the sealing cavity 36.

The electrically conductive terminals 40 are positioned within the dielectric terminal support 50 and the dielectric sealing insert 60 surrounds the termination junctions at which the conductors 15 are terminated to the termination end 43′of the electrically conductive terminals 40. The dielectric sealing insert 60 extends to the rearward surface 53 of the dielectric terminal support 50. An insulative strain relief and outer boot 65 may be overmolded about the electrical cable 12 and housing 22. With this configuration, the conductors 15 of the electrical cable assembly 10 are sufficiently insulated and spaced apart so as to provide the desired electrical characteristics. In one application, such an electrical cable assembly 10 is rated for operation at twenty Amps and six hundred Volts.

Although the mating section 31 of the first housing component 23 is depicted as a receptacle having male electrically conductive terminals and configured to receive a plug section of a mating connector (not shown) with female electrically conductive terminals (not shown), it may be possible to reverse the configurations of the mating section 31 and the plug section of the mating connector so that the male electrically conductive terminals are positioned within the plug section of the mating connector and the female electrically conductive terminals are positioned within the mating section 31. Still further, it may be possible to create a hybrid array of male and female electrically conductive terminals mix the male and female terminals within each connector.

During assembly, first housing component 23 may be provided with the dielectric terminal support 50 mounted therein and with the electrically conductive terminals 40 positioned within the holes or bores 52 of the dielectric terminal support. In such case, the termination end 43 of each electrically conductive terminal 40 extends rearwardly from the dielectric terminal support 50. The electrical cable 12 is prepared by removing a portion of the cable dielectric sheath 14 that surrounds the electrically conductive wires 13. A length of the outer dielectric sheath 16 of each of the electrically conductive wires 13 is stripped or removed so as to remove a length of the conductors 15 exposed. The second housing component 24 is then slid onto the electrical cable 12 or the second housing component may be slid on to the electrical cable 12 before the electrically conductive wires 13 are prepared. Each of the electrically conductive wires 13 is terminated to one of the electrically conductive terminals 40 such as by soldering to create a termination junction between the electrically conductive wire 13 and the electrically conductive terminal 40. The second housing component 24 is then slid along the electrical cable 12 towards first housing component 23. The second housing component 24 is rotated relative to the first housing component 23 with the threaded section 25 of the first housing component engaging the threaded section 26 of the second housing component to screw together the first housing component and the second housing component to secure the two housing components and form the housing 22.

A first dielectric layer 61 is then inserted within sealing cavity 36 of the second housing component and along the rearward surface 53 of the dielectric terminal support 50. In one configuration, the depth of the first dielectric layer 61 in a direction generally parallel to the mating axis 17 of the electrical connector 20 is thinner than the second dielectric layer 62 and may be between approximately four and ten mm. The first dielectric layer 61 is cured and then the second dielectric layer 62 is inserted within the sealing cavity 36 and the second dielectric layer is cured. In some applications, it may be possible to apply the second dielectric layer 62 without fully curing the first dielectric layer 61. The first dielectric layer 61 and the second dielectric layer 62 combine to form the dielectric sealing insert 60. Additional dielectric layers may also be provided and form a portion of the dielectric sealing insert. The dielectric sealing insert 60 may extend to the outer surfaces of the sealing cavity 36 to laterally fill the sealing cavity. The first dielectric layer 61 and the second dielectric layer 62 may be formed by inserting a nozzle (not shown) past the cable end 28 of the housing and through the opening 37 into the sealing cavity. An insulative strain relief and outer boot 65 may be overmolded about the electrical cable 12 and housing 22 as a final step of assembling electrical cable assembly 10.

Although the electrical cable assembly 10 is described above with the dielectric terminal support 50 being inserted into the first housing component 23 and the electrically conductive terminals 40 being inserted into the dielectric terminal support, it may be possible to insert mold the dielectric terminal support 50 within the first housing component 23 and with the electrically conductive terminals 40 therein. In another configuration, it may be possible to terminate each of the electrically conductive wires 13 to the electrically conductive terminals 40 and then insert each of the terminated terminals into the dielectric terminal support 50.

### INDUSTRIAL APPLICABILITY

The industrial applicability of the cable assembly described herein will be readily appreciated from the foregoing discussion. The present disclosure is applicable to systems and machines in which it is desirable to provide an electrical connection between two components. The electrical cable assembly 10 provides improved electrical performance for relatively high voltage and current applications in severe environmental conditions. The electrical cable assembly reduces the likelihood of voltage discharge and other types of failure.

In one aspect, an electrical cable assembly 10 for mating with a mating connector (not shown) is provided. The electrical cable assembly 10 has a housing 22 with a mating end 27, a cable end 28, and a sealing cavity 36 between the mating end and the cable end. An electrical cable 12 has a plurality of electrically conductive wires 13 therein with each electrically conductive wire having an outer dielectric sheath 16 therearound. A plurality of electrically conductive terminals 40 are positioned within the housing 22 with each electrically conductive terminal 40 being terminated to one of the electrically conductive wires 13 at a termination junction. Each termination junction is positioned within the sealing cavity 36. A dielectric terminal support 50 is provided for supporting a portion of the electrically conductive terminals 40 in a spaced apart array. A dielectric sealing insert 60 is located within the sealing cavity 36 to surround each termination junction. The dielectric sealing insert 60 has a first dielectric layer 61 and a second dielectric layer 62.

In another aspect, a method is provided for assembling an electrical cable assembly 10. An electrical cable 12 having a plurality of electrically conductive wires 13 is provided. Each electrically conductive wire 13 has an outer dielectric sheath 16 therearound. An electrical connector 20 having a housing 22 and plurality of electrically conductive terminals 40 is provided. The housing includes a mating end 27, a cable end 28, and a sealing cavity 36 between the mating end and the cable end. An electrically conductive terminal 40 is terminated to each electrically conductive wire 13 at a termination junction. Each termination junction is positioned within the sealing cavity 36. A first dielectric layer 61 and a second dielectric layer 62 are inserted into the sealing cavity 36 to form a dielectric sealing insert 60 within the sealing cavity. Each termination junction is sealed within the dielectric sealing insert 60.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An electrical cable assembly for mating with a mating connector along a mating axis, comprising:
a housing having a mating end, a cable end, and a sealing cavity between the mating end and the cable end;
a cable having a plurality of electrically conductive wires therein, each electrically conductive wire having an outer dielectric sheath therearound;
a plurality of electrically conductive terminals positioned within the housing, each electrically conductive terminal being terminated to one of the electrically conductive wires at a termination junction, each termination junction being positioned within the sealing cavity;
a dielectric terminal support for supporting a portion of the electrically conductive terminals in a spaced apart array; and
a dielectric sealing insert within the sealing cavity to surround each termination junction, the dielectric sealing insert having a first dielectric layer and a second dielectric layer.

2. The electrical cable assembly of claim 1, wherein the first dielectric layer of the dielectric sealing insert engages the dielectric terminal support and the first dielectric layer is thinner than the second dielectric layer along the mating axis.

3. The electrical cable assembly of claim 1, wherein the dielectric sealing insert is formed of an epoxy.

4. The electrical cable assembly of claim 1, wherein the dielectric sealing insert further surrounds a portion of the dielectric sheath of each electrically conductive wire.

5. The electrical cable assembly of claim 1, wherein the dielectric sealing insert engages the dielectric terminal support and outer surfaces of the sealing cavity.

6. The electrical cable assembly of claim 1, wherein the dielectric terminal support is formed of an elastomeric material.

7. The electrical cable assembly of claim 6, wherein the dielectric terminal support is formed of neoprene.

8. The electrical cable assembly of claim 1, wherein the housing is formed of a conductive material.

9. The electrical cable assembly of claim 1, wherein the housing is formed of a first housing component and a second housing component.

10. The electrical cable assembly of claim 9, wherein the first housing component and the second housing component are screwed together.

11. A method of assembling an electrical cable assembly comprising:
providing a cable having a plurality of electrically conductive wires therein, each electrically conductive wire having an outer dielectric sheath therearound;
providing an electrical connector having a housing and a plurality of electrically conductive terminals therein, the housing including a mating end, a cable end, and a sealing cavity between the mating end and the cable end;
terminating an electrically conductive terminal to each electrically conductive wire at a termination junction, each termination junction being positioned within the sealing cavity; and
inserting a first dielectric layer and a second dielectric layer to form a dielectric sealing insert within the sealing cavity, each termination junction being sealed within the dielectric sealing insert.

12. The method of claim 11, wherein the inserting step includes inserting the first dielectric layer within the sealing cavity and subsequently inserting the second dielectric layer within the sealing cavity, the second dielectric layer being positioned between the first dielectric layer and the cable end of the housing.

13. The method of claim 12, further including the steps of curing the first dielectric layer before applying the second dielectric layer.

14. The method of claim 12, further including the steps of fully curing the first dielectric layer before applying the second dielectric layer.

15. The method of claim 11, wherein the dielectric sealing insert is an epoxy.

16. The method of claim 11, further including inserting a nozzle past the cable end of the housing and into the sealing cavity to facilitate inserting the first dielectric layer within the sealing cavity.

17. The method of claim 11, further including providing a dielectric terminal support within the housing and positioning a portion of each electrically conductive terminal within the dielectric terminal support.

18. The method of claim 17, wherein the inserting step includes forming the first dielectric layer within the sealing cavity adjacent the dielectric terminal support and subsequently forming the second dielectric layer within the sealing cavity.

19. The method of claim 17, wherein the portion of each electrically conductive terminal is positioned within the dielectric terminal support before the electrically conductive terminals are terminated to the electrically conductive wires.

20. The method of claim 11, wherein the housing includes a first housing component and a second housing component, the first housing component and the second housing component are secured together after the electrically conductive terminals are terminated to the electrically conductive wires.
